(19) United States
(12) Patent Application Publication
(10) Pub. No.: US 2006/0222750 A1
(43) Pub. Date: Oct. 5, 2006

(54) Method of preventing migration of water and coloring matter in foods

(76) Inventors: Hideki Shimizu, Hiroshima (JP); Hisao Shimizu, Hiroshima (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/094,167

(22) Filed: Mar. 31, 2005

(51) Int. Cl. A23L 1/05

(52) U.S. Cl. 426/573

(57) ABSTRACT

A method of preventing inter-foodstuff migration of water and a coloring matter in combining more than two foodstuffs is provided, wherein, in preparation of foods obtainable by direct combination of more than one foodstuff at least including one foodstuff containing either or both of water and the coloring matter, a water/coloring matter migration-proof agent in the form of sol or gel consisting of thickening polysaccharide or a mixture of thickening polysaccharide, oils-and-fats, and water-insoluble food fibers is interposed between one foodstuff containing the water or the coloring matter and the other contacting the one foodstuff. The thickening polysaccharide may be arum root or glucomannan in the form of sol or dissolved-in-water of refined flour or pasted glucomannan. The water/coloring matter migration-proof agent may be a mixture of a coagulating agent and a substrate consisting of arum root or glucomannan in the form of powder, sol or dissolved-in-water, or pasted glucomannan.

### BACKGROUND OF THE INVENTION

1. Field of the Invention

This invention relates to a method of preventing migration of water and a coloring matter in foods, and more particularly, to a method of preventing inter-foodstuff migration of water or a coloring matter from occurring in the case of preparation of foods supposed to be obtainable by a direct combination of more than one foodstuff at least including one foodstuff containing much water or both much water and the coloring matter.

2. Description of the Prior Art

A method disclosed in Japanese Patent Laid-open No. 9-70263 is well known as a method of preventing water contained in dough (i.e., creamy dough) filled in mass-produced foodstuffs internally containing much water, like foods coated with batter such as cream croquettes, from being so expanded by heating as to leach out to the outside or give cracks to food coats made of batter, in the case of the preparation of the above foodstuffs by heating in an oven etc.

The above method aims at reinforcing a strength of the food coat serving as an outer surface in such a manner as to give elasticity to the whole food coat by coating an inside of the food coat with an elastic film containing glucomannan etc., thereby preventing the food coat from being cracked at the time of heating.

However, in the preparation of the foods, inter-foodstuff migration of the water or a coloring matter contained in the water gives rise to problems frequently in cases other than the case of the foods supposed to be prepared by heating as described the above. For instance, topping or coating of a foodstuff containing the coloring matter and the water in large quantities, such as ketchup, sauce and jam, to a highly water-permeable foodstuff, like crepe dough, is given as one of the cases where the inter-foodstuff migration would occur regardless of the expansion of the water by heating. In this case, outflow or the migration of the water and the coloring matter toward the dough occurs with a passage of time, which causes damages to tastes or an external appearance of the food in itself, resulting in a problem of an impairment of a commercial value.

Further, when adding of one foodstuff containing both the water and a vivid coloring matter, like grapes and strawberries, to the other foodstuff containing much water, such as a yogurt, a milkshake and a pudding is put into effect, the migration of the coloring matter from one foodstuff to the other also occurs, which causes damages to tastes or an external appearance of the food in itself, resulting in the problem of the impairment of the commercial value too.

It is thus seen from the above that there has been not yet provided any method of effectively preventing the inter-foodstuff migration of the water and the coloring matter in non heat-treated foods, like the foods described the above.

### SUMMARY OF THE INVENTION

It is an object of the present invention to provide a method of preventing migration of water and a coloring matter from occurring in the case of preparation of foods that do not always involve expansion or vaporization of the water by heating as described the above.

Another object of the present invention is to, when combining one foodstuff containing much water, like an ice cream and a soft ice cream or a bean-jam-filled wafer (which is also called “monaka”), with the other foodstuff such as crepe dough, a tortilla, a cone, and a corn-made coating material, prevent migration of water from the one foodstuff toward the other such as the coating material by impregnating, with a water migration-proof agent, a portion between an intra-foodstuff serving as the one foodstuff and the coating material serving as the other foodstuff.

A further object of the present invention is to provide a food that eliminates a problem of quality degradations attributed to the migration of the water as described the above, even after freezing and thawing of the above food.

Still further objects of the present invention other than the above are to make it possible to prevent outflow of the coloring matter contained in sarcocarp or fading of the coloring matter to ensure that a more effective prevention of the migration of the coloring matter etc. having been added in the dough in the course of preparation of the food and the migration of the water is attained, and also, to employ a thickening polysaccharide such as glucomannan, as an additive or a coating agent without a need for extra saccharides or oils-and-fats.

According to a first aspect, a method of the present invention to attain the above objects comprises, in a method of preparing a food supposed to be obtainable by a direct combination of more than one foodstuff including at least one foodstuff containing either or both of much water and a coloring matter, a step of interposing, between the one foodstuff containing the water or the coloring matter and the other foodstuff making contact with the above one foodstuff, a water/coloring matter migration-proof agent that is prepared in the form of sol or gel consisting of a thickening polysaccharide or a mixture of the thickening polysaccharide, oils-and-fats, and water-insoluble food fibers.

According to a second aspect, the method of the present invention is characterized in that the thickening polysaccharide is specified as an arum root or glucomannan that is prepared in the form of sol or dissolved-in-water of refined flour, or alternatively, pasted glucomannan.

According to a third aspect, the method of the present invention is characterized in that the thickening polysaccharide contains at least one or more compounds selected from a group consisting of guar gum, tare gum, gelatin, locust bean gum, sodium alginate, pectin, agar, curdlan, xanthane gum, carrageenan, chitin, chitosan, starch, casein and pullulan.

According to a fourth aspect, the method of the present invention is characterized in that the glucomannan is in the form of powder having an average particle diameter in the range of 10 to 350 μm, and the thickening polysaccharide is contained in an amount of 0.1 to 2% by weight.

According to a fifth aspect, the method of the present invention is characterized in that the water-insoluble food fibers are specified as a coating substrate mainly consisting of cellulose etc.

According to a sixth aspect, the method of the present invention is characterized in that freezing or semi-freezing of the food having been coated with the water/coloring matter migration-proof agent according to claim 1 or 2 is put into effect.

According to a seventh aspect, the method of the present invention is characterized in that one foodstuff containing either or both of much water and the coloring matter is specified as fruits or sarcocarp, and coating of the above one foodstuff with the water/coloring matter migration-proof agent is put into effect before the above one foodstuff is combined with the other foodstuff.

According to an eighth aspect, the method of the present invention is characterized in that the water/coloring matter migration-proof agent is a mixture of a coagulating agent and a substrate consisting of the arum root or the glucomannan that is prepared in the form of powder, sol or dissolved-in-water, or alternatively, pasted glucomannan.

According to a ninth aspect, the method of the present invention is characterized in that the coagulating agent contains at least one or more compounds selected from a group consisting of alkaline hydroxides, carbonates and phosphates such as calcium hydroxide, sodium hydroxide, potassium hydroxide, sodium carbonate, potassium carbonate, trisodium phosphate and tripotassium phosphate, and basic amino acids such as arginine, histidine, methionine, lysine and ornithine.

According to a tenth aspect, the method of the present invention is characterized in that a concentration of the glucomannan is in the range of 0.1 to 5.0% by weight with respect to water.

According to an eleventh aspect, the method of the present invention is characterized in that a concentration of the thickening polysaccharide exclusive of the substrate is in the range of 0 to 10% by weight with respect to water.

According to a twelfth aspect, the method of the present invention is characterized in that the coagulating agent is contained in an amount of 0.05 to 15% by weight with respect to the substrate.

According to a thirteenth aspect, a method of the present invention comprises, in a process of putting a seasoning material, a coloring material, a decoration material and other edible materials all containing much water to a surface of a water-permeable food substrate made of an edible material, a step of applying the water/coloring material migration-proof agent according to claim 8 to the food substrate surface specified as a surface serving to put the edible material, thereby impregnating the above food substrate surface with the water/coloring matter migration-proof agent to allow formation of a waterproof film or layer.

According to a fourteenth aspect, the method of the present invention comprises, in a process of coating or receiving an intra-foodstuff containing much water with or in a water-permeable and edible coating foodstuff, a step of applying the water/coloring matter migration-proof agent according to claim 8 to either or both of an inner surface of the coating foodstuff and a surface of the intra-foodstuff, thereby impregnating either or both of the above surfaces with the water/coloring matter migration-proof agent to allow formation of a waterproof film or layer.

### BRIEF DESCRIPTION OF THE DRAWINGS

The foregoing and other objects and features of the invention will become apparent from the following description of preferred examples of the invention with reference to the accompanying drawings, in which:

FIGS. 1A and 1B are photographs showing results of an experiment of outflow of a coloring matter on a yogurt having been treated according to a method of the present invention and on a yogurt having been given no treatment;

FIGS. 2A and 2B are photographs showing states of a change in migration of water in crepe dough at the beginning of an experiment in accordance with Example 4 of the present invention and after a lapse of one hour from the beginning of the above experiment; and

FIGS. 3A and 3B are photographs showing states of a change in migration of water in crepe dough at the beginning of an experiment in accordance with Comparative Example 4 corresponding to the above Example 4 and after the lapse of one hour from the beginning of the above experiment.

### DETAILED DESCRIPTION OF THE PREFERRED EMBODIMENT

First of all, a method of preventing migration of water containing a coloring matter according to the present invention is mainly described.

In researches into subject matters of the present invention, the present applicant and others proved that the method of the present invention enables an extensive application to various kinds of foods and drinks, and, in particular, effectively works on keeping of a food quality in regard to a process of preparation such as heating, freezing and thawing at the time of processing of the foods, or to a course of distribution of the foods before consumers get to eat.

In particular, the method of the present invention is effective in preventing outflow of the coloring matter contained in sarcocarp or fading of the coloring matter from occurring in the case of adding of the sarcocarp etc., permitting a contribution toward stability of the food quality in the process of preparation of the foods or in the course of distribution of the foods.

Further, the method of the present invention is also supposed to effectively work on highly hygroscopic foodstuffs etc.

From results of a variety of examinations having been made to solve the above problems, it was appreciated that the method of the present invention provides high effectiveness when using a thickening polysaccharide, particularly, glucomannan.

Specifically, a procedure of preparing a glucomannan solution, and then adding the sarcocarp etc. in a food such as a yogurt, a milkshake and a pudding after coating of the above sarcocarp etc. with the prepared glucomannan solution proved to be capable of preventing the outflow of the coloring matter contained in the sarcocarp, and also of preventing the outflow of the coloring matter at the time of thawing of the food, even after a repetition of freezing and thawing of the food.

The glucomannan is a storable polysaccharide contained in a tuber of arum root, and shares about 70 to 80% in the arum root.

In general, the arum root is used in the form of so-called refined flour of arum root prepared by slicing and drying the arum root after washing with water, and finally removing starches etc. from the dried arum root, and the glucomannan is contained in an amount of 70 to 80% in the refined flour of arum root. However, the present invention may also employ the arum root that is prepared in the form of sol by directly mashing the arum root, or alternatively, in the form of dissolved (swelled)-in-water of the refined flour of arum root.

The method of the present invention involves the use of refined glucomannan (which is available by a trade name of ┌Rheolex RS┘) having been patented by the present applicant as described in Japanese Patent Publication No. 6-97960. The refined glucomannan effectively works to be capable of preventing food quality degradations during the distribution of the foods in a semi-frozen state in such a manner as to form a fixed coating at the time of freezing by coating the sarcocarp as described above or even by adding the thickening polysaccharide, permitting the contribution toward an improvement on keeping of the food quality.

While details of the present invention are now described specifically with reference to the following Examples, it is to be understood that the present invention is not limited to these Examples.

### EXAMPLE 1

After preparation of a solution containing 0.7% of the refined flour of arum root or the glucomannan, the sarcocarp of grapes or strawberries etc. having been coated with the refined glucomannan solution was added in the yogurt or the milkshake etc. Then, an examination on the outflow of the coloring matter was made based on a change with the passage of days.

The result of the examination was that neither the outflow of the coloring matter from the sarcocarp to the yogurt or the milkshake, nor the fading of the coloring matter was recognized even after the lapse of one week.

### COMPARATIVE EXAMPLE 1

The sarcocarp was added, as it was, in the yogurt or the milkshake etc. without using any refined flour of arum root or the glucomannan that had been used in Example 1. Then, an observation on the outflow of the coloring matter was made after the lapse of one week. The result of the observation was that not only the outflow of the coloring matter from the sarcocarp to the yogurt or the milkshake, but also the fading of the coloring matter was recognized.

### EXAMPLE 2

Likewise, a confirmation as to the outflow of the coloring matter was made after the lapse of one week by taking a means of freezing and then thawing the same food as in the above Example 1. The result of the confirmation was that neither the outflow of the coloring matter from the sarcocarp, nor the fading of the coloring matter was recognized.

### COMPARATIVE EXAMPLE 2

As an example in comparison with the Example 2, a sample prepared by adding the sarcocarp in the above foodstuff without using any refined flour of arum root or the glucomannan was subjected to thawing after freezing. Then, an observation on the outflow of the coloring matter was made for one week. The result of the observation was that not only the outflow of the coloring matter from the sarcocarp, but also the fading of the coloring matter was recognized like the result in the Comparative Example 1.

Incidentally, it was found that the freezing and the thawing of the above food lead to an aggravation of the outflow of the coloring matter from the sarcocarp and the fading of the coloring matter.

### EXAMPLE 3

After the freezing of the sarcocarp etc. having been immersed in the solution of the refined flour of arum root or the glucomannan like the Examples 1 and 2, the sarcocarp was stored in the frozen state for a period as long as half a year. Then, an observation on a state of the sarcocarp obtained after the thawing was made. The result of the observation was that neither the outflow of the coloring matter from the sarcocarp, nor the fading of the coloring matter was recognized.

In addition, a change in food quality such as burning due to the storage for a long period of time was not recognized too.

### COMPARATIVE EXAMPLE 3

As an example in comparison with the Example 3, a comparative experiment was made on the sarcocarp having been subjected to thawing after freezing, among samples of the sarcocarp having been prepared without using the refined flour of arum root or the glucomannan. The result of the comparative experiment was that a failure in keeping of the food quality occurred before half a year was reached, in which case, the outflow of the coloring matter from the sarcocarp and the fading of the coloring matter were both recognized at the time when one week elapsed.

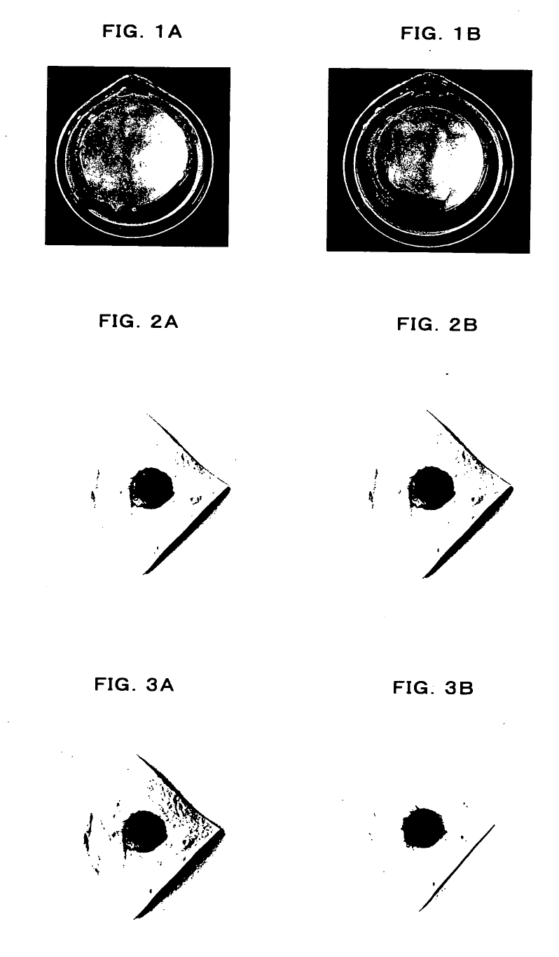

The results of an experiment on the preparation of the foods having been treated using the method of the present invention are now described more specifically with reference to FIGS. 1A and 1B. In this experiment, banana chips having a width of about 3 to 4 mm were immersed in a coloring solution (No. 102 of Red) to provide wholly colored banana chips, which were then added in a yogurt on the market after separation of the banana chips from the coloring solution.

FIG. 1A is a photograph showing the result of the experiment of the outflow of the coloring matter on a sample containing the colored banana chips having been coated with the solution containing 0.7% of ┌Rheolex RS (which is the trade name of the glucomannan having been manufactured according to a method described in Japanese Patent Publication No. 6-97960 by the present applicant)┘. FIG. 1B is a photograph showing the result of the experiment of the outflow of the coloring matter on a sample containing the colored banana chips having been given no coating treatment. These photographs are given to make a comparison of the outflow state of the coloring matter between the samples having been both subjected to thawing (at room temperature) after freezing.

From the above results, it is evident that exudation of the red coloring solution from the sample containing the colored banana chips having been given no coating treatment is found, whereas the sample containing the colored banana chips having been given the coating treatment causes no exudation of the coloring solution at all.

Incidentally, while the above Examples have all taken the procedure of adding the sarcocarp in the food after coating of the sarcocarp with the glucomannan solution, it has been also experimentally confirmed that, when both the sarcocarp and the thickening polysaccharide such as the glucomannan were added in the foodstuff in itself containing much water, the migration of the coloring matter or the water was prevented like the case of the coating of the sarcocarp with the glucomannan solution.

According to the above Examples, even if adding of the sarcocarp in the yogurt or the milkshake etc. is put into effect, the use of the glucomannan enables the preparation of the foods causing neither the migration of the water, nor the outflow and fading of the coloring matter in the sarcocarp, and is thus supposed to meet an expectation of the improvement on a quality of products.

Furthermore, the use of the glucomannan also makes it possible to prevent the migration of the water in the sarcocarp by freezing a mixture of the sarcocarp with the dough of sponge cakes or cookies, permitting an epoch-making prolongation of a period in keeping of the food quality.

A method of preventing the migration of the water according to the present invention is now described.

A water migration-proof agent for use in the embodiment of the present invention is prepared by adding a coagulating agent to a substrate consisting of the arum root or glucomannan that is prepared in the form of powder, gel or dissolved-in-water, or alternatively, pasted glucomannan. Among the above various forms available in the arum root, the powdered arum root is supposed to be used in the form of so-called refined flour of arum root prepared by slicing and drying the arum root after washing with water, and finally removing starches etc. from the dried arum root, and the glucomannan is contained in an amount of 70 to 80% in the refined flour of arum root. The present invention may also employ the arum root that is prepared in the form of sol by directly mashing the arum root, or alternatively, in the form of dissolved (swelled)-in-water of the refined flour of arum root.

The glucomannan is the storable polysaccharide contained in the tuber of the arum root, and shares about 8 to 10% in the arum root. The glucomannan for use in the present invention involves the use of water-soluble glucomannan ┌which is available by the trade name of Rheolex RS (manufactured by Shimizu Chemical Corporation)┘ that is refined with alcohol. However, it may be expected that the use of generally available glucomannan showing variations in bloating tendency (solubility) provides the same effect as the above.

The above agent may include, in addition to the substrate, at least one or more compounds as thickening polysaccharides selected from a group consisting of guar gum, tare gum, gelatin, locust bean gum, sodium alginate, pectin, agar, curdlan, xanthane gum, carrageenan, chitin, chitosan, starch, casein and pullulan, in which case, an addition of these thickening polysaccharides is supposed to give elasticity and hardness to a prospective waterproof film or layer to be formed, permitting a more reliable prevention of the migration of the water.

Available coagulating agents for the present invention include an agent containing at least one or more compounds selected from a group consisting of alkaline hydroxides, carbonates and phosphates such as calcium hydroxide, sodium hydroxide, potassium hydroxide, sodium carbonate, potassium carbonate, trisodium phosphate and tripotassium phosphate, and basic amino acids such as arginine, histidine, methionine, lysine and ornithine.

The concentration of the glucomannan in the substrate is preferably in the range of about 0.1 to 5.0% by weight with respect to water. The glucomannan having the concentration equal to or less than 0.1% is not enough to attain formation of the waterproof film or layer. Conversely, the glucomannan having the concentration exceeding 5% provides poor fluidity for the water migration-proof agent, leading to a difficulty in coating or spraying of the agent.

The concentration of the thickening polysaccharide exclusive of the substrate is preferably in the range of 0 to 10% by weight with respect to water. The thickening polysaccharide having the concentration exceeding 10% provides a lack of free water contained in the water migration-proof agent, leading to the difficulty in the coating or spraying of the agent to the dough etc., likewise. The coagulating agent is preferably contained in an amount of 0.05 to 15% by weight with respect to the glucomannan. The coagulating agent contained in an amount exceeding 15% causes damages to the gel because of an increase in alkalinity of the water migration-proof agent in excess, resulting in an occurrence of cases where the coagulating agent fails to meet the purpose of use.

The above method of preventing the migration of the water in the foods using the above water migration-proof agent is now described.

When putting a seasoning material, a coloring material, a decoration material and other edible materials all containing much water to the surface of a water-permeable food substrate made of an edible material, like the case of topping or coating of the foods containing much water such as ketchup onto the crepe dough, for instance, the above method of the present invention is so taken as to apply the water migration-proof agent to the food substrate surface specified as the surface serving to put the edible material, thereby allowing formation of a waterproof film or layer.

Alternatively, when coating or receiving an intra-foodstuff containing much water such as an ice cream, a soft ice cream and a candy with or in a water-permeable and edible coating foodstuff such as a corn-made coating material and a cone, the above method of the present invention is so taken as to apply the water migration-proof agent, by means of spraying or coating, to either or both of an inner surface of the coating foodstuff and a surface of the intra-foodstuff, thereby impregnating either or both of the above surfaces with the above water migration-proof agent to allow formation of a waterproof impregnation layer. The cone and the coating material described the above are not limited to the corn-made materials, and the crepe dough or other edible materials are also supposed to be available.

When using the above method of the present invention to put the preparation of the food into effect by preparing the solution containing the glucomannan, coating or spray-coating a sheet-shaped food such as the crepe dough and a tortilla with the above solution, and then giving topping or coating etc. of the ketchup, a sauce or a gravy to the dough after the dough is dried, the surface of the dough is supposed to be coated with a layer impregnated with the water migration-proof agent, thereby effectively preventing the migration of the water toward the dough. Further, the above method of the present invention is also capable of preventing the migration of the water toward the dough at the time of thawing, even after giving the repetition of freezing and thawing to the foods described the above.

While drying of the surface of the dough etc. after coating (spraying) of the water migration-proof agent is preferably required to stabilize the film (layer), it is not always necessary to subject the dough surface to drying, if stabilization of the film takes place at high speed. In addition, from the results of various experiments, it became evident that the use of the glucomannan is supposed to be the most effective way of preventing the migration of the water.

Furthermore, the use of the above water migration-proof agent for the cone of the soft ice cream and the ice cream or the coat of a cone bean-jam-filled wafer and a bean-jam-filled wafer used for a Japanese-style confection makes it possible to prevent the migration of the water toward the cone or the coat of the cone bean-jam-filled wafer, and is also supposed to meet an expectation of the contribution toward the improvement of the food quality, permitting a prolongation of a period in keeping of the food quality.

While the specific details of the present invention are now described with reference to the following Examples, it is to be understood that the present invention is not limited to these Examples, as already described the above.

### Example 4

After coating of the crepe dough with a waterproof film (layer) by spraying, uniformly and in a small thickness, the crepe dough with a mixed solution prepared by adding 0.025 g of calcium hydroxide in a solution containing 0.5% of the refined flour of arum root or the glucomannan, the surface of the dough was subjected to drying in order to more stabilize the waterproof film (layer), and 3 g of a chili sauce was put on the dried dough surface. Then, an observation on the change with the passage of time was made after the lapse of one hour. The result of the observation was that no migration of the water from the chili sauce into the dough was recognized. FIG. 2A is a photograph showing the state of the migration of the water at the beginning of an experiment, and FIG. 2B is a photograph showing the state of the migration of the water after the lapse of one hour from the beginning of the experiment.

### COMPARATIVE EXAMPLE 4

As an example in comparison with the Example 4, an experiment was made, using the same method as the Example 4, on the crepe dough having been not given the coating treatment. Then, the observation on the change with the passage of time was made after the lapse of one hour. The result of the observation was the occurrence of the obvious migration of the chili sauce into the dough, so that the migration of the water was recognized. FIG. 3A is a photograph showing the state of the migration of the water at the beginning of an experiment, while FIG. 3B is a photograph showing the state of the migration of the water after the lapse of one hour from the beginning of the experiment.

### EXAMPLE 5

Like the Example 4, an observation on the change of the dough obtained after the thawing was made by taking a means of freezing and then thawing the same food as in the Example 4. The result of the observation was that no migration of the water etc. was recognized.

### COMPARATIVE EXAMPLE 5

As an example in comparison with the Example 5, an observation on the change of the dough obtained after the thawing was made by taking the means of freezing and then thawing the same food as in the Comparative example 4, like the Example 5. The result of the observation was the occurrence of the migration of the chili sauce into the dough, so that the migration of the water was recognized.

According to the method of preventing the migration of the water in the foods as described the above, even when bringing one foodstuff containing much water into contact with the other hygroscopic or water-permeable foodstuff such as the crepe dough, the tortilla, the cone, and the corn-made coating material, it is possible to prevent effectively both the migration of the water from one foodstuff to the other and the degradation of the food quality due to the above migration of the water.

Further, the method of the present invention also offers an advantage of being able to eliminate problems inclusive of the food quality degradations due to the migration of the water, even after the freezing and the thawing of the foods like the foods described the above.

What is claimed is:

1. In a process of preparing a food supposed to be obtainable by a direct combination of more than one foodstuff at least including one foodstuff containing either or both of much water and a coloring matter, a method of preventing migration of water and a coloring matter in foods, comprising a step of interposing, between said one foodstuff containing the water or the coloring matter and the other foodstuff making contact with said one foodstuff, a water/coloring matter migration-proof agent that is prepared in the form of sol or gel consisting of a thickening polysaccharide or a mixture of the thickening polysaccharide, oils-and-fats, and water-insoluble food fibers.

2. The method of preventing migration of water and a coloring matter in foods according to claim 1, wherein the thickening polysaccharide is specified as arum root or glucomannan that is prepared in the form of sol or dissolved-in-water of refined flour, or alternatively, pasted glucomannan.

3. The method of preventing migration of water and a coloring matter in foods according to claim 2, wherein the thickening polysaccharide contains at least one or more compounds selected from a group consisting of guar gum, tare gum, gelatin, locust bean gum, sodium alginate, pectin, agar, curdlan, xanthane gum, carrageenan, chitin, chitosan, starch, casein and pullulan.

4. The method of preventing migration of water and a coloring matter in foods according to claim 1 or 2, wherein the glucomannan is in the form of powder having an average particle diameter in the range of 10 to 350 μm, and the thickening polysaccharide is contained in an amount of 0.1 to 2% by weight.

5. The method of preventing migration of water and a coloring matter in foods according to claim 1 or 2, wherein the water-insoluble food fibers are specified as a coating substrate mainly consisting of cellulose etc.

6. The method of preventing migration of water and a coloring matter in foods according to claim 1 or 2, wherein freezing or semi-freezing of the food having been coated with the water/coloring matter migration-proof agent is put into effect.

7. The method of preventing migration of water and a coloring matter in foods according to claim 1 or 2, wherein the one foodstuff containing either or both of much water and the coloring matter is specified as fruits or sarcocarp, and coating of said one foodstuff with the water/coloring matter migration-proof agent is put into effect before said one foodstuff is combined with the other foodstuff.

8. The method of preventing migration of water and a coloring matter in foods according to claim 1, wherein the water/coloring matter migration-proof agent is a mixture of a coagulating agent and a substrate consisting of arum root or glucomannan that is prepared in the form of powder, sol or dissolved-in-water, or alternatively, pasted glucomannan.

9. The method of preventing migration of water and a coloring matter in foods according to claim 8, wherein the coagulating agent contains at least one or more compounds selected from a group consisting of alkaline hydroxides, carbonates and phosphates such as calcium hydroxide, sodium hydroxide, potassium hydroxide, sodium carbonate, potassium carbonate, trisodium phosphate and tripotassium phosphate, and basic amino acids such as arginine, histidine, methionine, lysine and ornithine.

10. The method of preventing migration of water and a coloring matter in foods according to claim 8, wherein a concentration of the glucomannan is in the range of 0.1 to 5.0% by weight with respect to water.

11. The method of preventing migration of water and a coloring matter in foods according to claim 8, wherein a concentration of the thickening polysaccharide exclusive of the substrate is in the range of 0 to 10% by weight with respect to water.

12. The method of preventing migration of water and a coloring matter in foods according to claim 8, wherein the coagulating agent is contained in an amount of 0.05 to 15% by, weight with respect to the substrate.

13. In a process of putting a seasoning material, a coloring material, a decoration material or other edible materials all containing much water to a surface of a water-permeable food substrate made of an edible material, a method of preventing migration of water and a coloring matter in foods, comprising a step of applying the water/coloring matter migration-proof agent according to claim 8 to an edible substrate surface specified as a surface serving to put the edible material, thereby impregnating said surface with said water/coloring matter migration-proof agent to allow formation of a waterproof film or layer.

14. In a method of coating or receiving an intra-foodstuff containing much water to or in a water-permeable and edible coating foodstuff, a method of preventing migration of water and a coloring matter in foods, comprising a step of applying the water/coloring matter migration-proof agent according to claim 8 to either one or both of an inner surface of the coating foodstuff and a surface of the intra-foodstuff, thereby impregnating either or both of said surfaces with said water/coloring matter migration-proof agent to allow formation of a waterproof film or layer.
